(19) United States
(12) Patent Application Publication
(10) Pub. No.: US 2013/0080950 A1
(43) Pub. Date: Mar. 28, 2013

(54) INCREMENTALLY SELF-ORGANIZING WORKSPACE

(71) Applicants: Jack A. Alford, JR., Austin, TX (US); Scott H. Isensee, Austin, TX (US); James L. Lentz, Austin, TX (US); Kelly L. Lisai, Austin, TX (US)

(72) Inventors: Jack A. Alford, JR., Austin, TX (US); Scott H. Isensee, Austin, TX (US); James L. Lentz, Austin, TX (US); Kelly L. Lisai, Austin, TX (US)

(73) Assignee: International Business Machines Corporation, Armonk, NY (US)

(21) Appl. No.: 13/246,476

(22) Filed: Sep. 27, 2011

(51) Int. Cl. G06F 3/048

(52) U.S. Cl. 715/765

(57) ABSTRACT

A user interface organizing system and method are provided. The system includes an analyzer configured to evaluate object properties of each of a plurality of graphical elements displayed on a display device, compare the object properties of each of the plurality of graphical elements with every other graphical element, generate a degree of similarity for every possible pairing of graphical elements. The system also includes an aggregator configured to incrementally move each of the plurality of graphical elements towards at least one other graphical element based upon the degree of similarity.

### BACKGROUND

Many users of graphical desktop systems follow a practice of saving documents to the desktop so that while the documents are being edited, the documents are readily accessible without searching or navigating through a file system. In addition, specific document icons on the desktop can serve as reminders of work that the user must perform. Over time, the desktop can become cluttered, making it difficult for the user to locate a desired document, because the user must visually scan the desktop.

One time consuming way to manage a cluttered desktop is to manually file the documents away into folders. This is not only a time-consuming side task on the part of the user, but depending on the filing and manual document management skills of the user, documents may be filed away in a manner that makes them hard to retrieve later.

The problem of desktop clutter is exacerbated because sometimes many workers multitask on a number of projects, each of which may involve the creation or saving of a variety of documents each relating to a different topic onto the desktop. In many cases, the desktop system will “suggest” where to place documents. For example, when using “File>Save As” to save a new document or a new version of an existing document to the desktop, the desktop system must provide a location to place the document icon on the desktop. Typically the desktop places document icons in a grid, top to bottom, left to right. When the user is multiplexing between different projects, document icons are typically arranged chronologically without regard to project, topic or purpose.

### SUMMARY

Embodiments of a system are described. In one embodiment, the system is an automatic and incremental organizer of graphical elements with a user interface. The system includes an analyzer for evaluating the properties of objects that are represented graphically on a display device, comparing the object properties of each of graphical elements with every other graphical element, and generating a measurement of similarity for every possible pairing of graphical elements. The system also includes an aggregator for incrementally moving each of the plurality of graphical elements towards at least one other graphical element based upon the degree of similarity. Other embodiments of the system are also described. Embodiments described herein enable views of objects to incrementally self organize on the basis of similarities and differences in multiple attributes and to change their presentation over time to reflect relative frequency of use. On an operating system desktop, this self-organizing feature would sort objects into groups and, if accessed infrequently, gradually be removed from view on the desktop.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a user interface organization system.

FIG. 2 is a schematic block diagram illustrating one embodiment of the organizer.

FIG. 3 is a schematic block diagram illustrating one embodiment of graphical element movement.

FIG. 4 is a schematic block diagram illustrating one embodiment of a condensed graphical element.

FIG. 5 is a schematic flow chart diagram illustrating one embodiment of a method for organizing objects displayed on a user interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for organizing graphical elements of a user interface. More specifically, the system is able to analyze the object properties of every graphical element and compare those object properties with the object properties of every other graphical element. In another embodiment, the system may also continuously assess the relative similarity or dissimilarity of every graphical element with every other object in a distributed manner. The system then generates a degree of similarity between every possible pairing of graphical elements, and then based upon the degree of similarity, incrementally and gradually moves graphical elements.

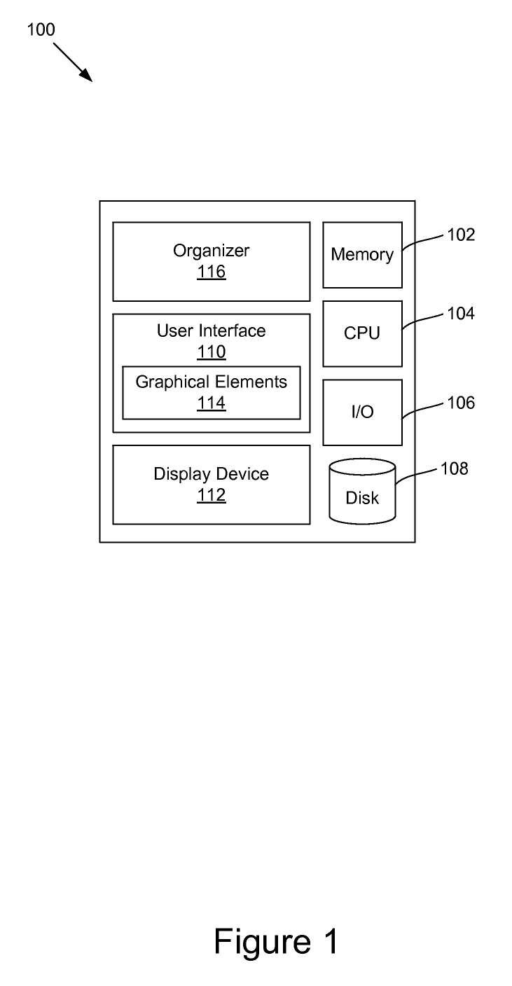

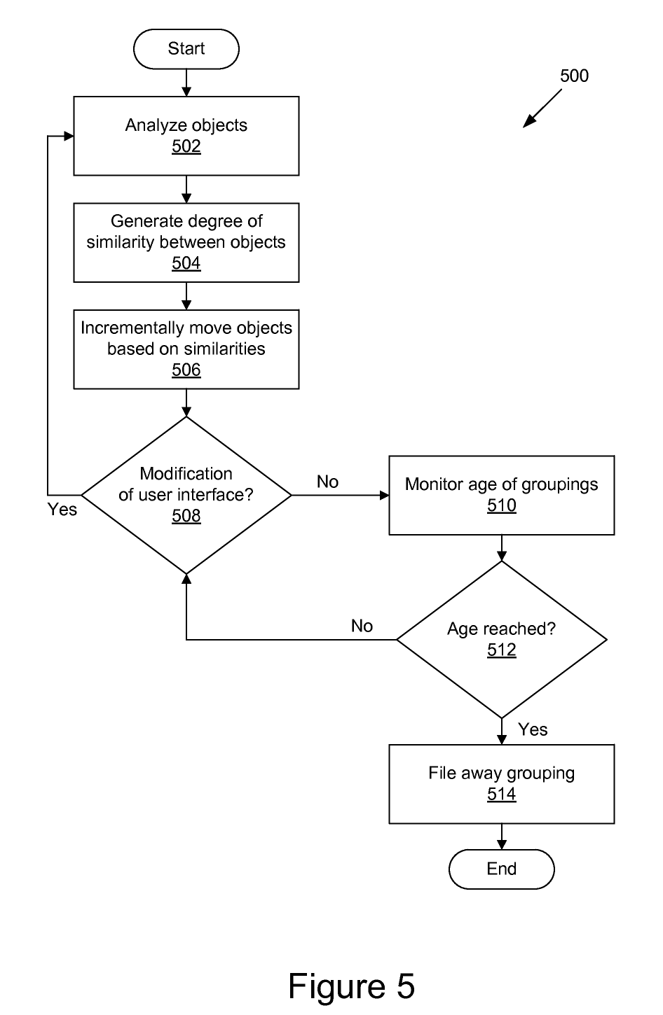

FIG. 1 depicts a schematic block diagram of one embodiment of a user interface organization system 100. The depicted system 100 includes various components, described in more detail below, that are capable of performing the functions and operations described herein. In one embodiment, at least some of the components of the system 100 are implemented in a computer system. For example, the functionality of one or more components of the system 100 may be implemented by computer program instructions stored on a computer memory device 102 and executed by a processing device 104 such as a CPU. The system 100 may include other components, such as a disk storage drive 108, input/output devices 106, a user interface 110, and a display device 112. Some or all of the components of the system 100 may be stored on a single computing device or on a network of computing devices. The system 100 may include more or fewer components or subsystems than those depicted herein. In some embodiments, the system 100 may be used to implement the methods described herein as depicted in FIG. 5.

In one embodiment, the user interface 110 is presented on the display device 112. The computing device which implements the user interface organization system 100 may be any computing device, including a desktop computer, laptop computer, mobile phone or other mobile device, or any other computing device capable of displaying the user interface 110. The user interface 110 may receive inputs from various sources, including manual input from a user via a mouse, a keyboard, a touch screen, or other input devices. The user interface 110 may also output the data in the user interface 110 onto the display device 112, such that the user interface 110 and any graphical elements 114 in the user interface 110 may be displayed to the user.

The user interface 110 may include any number of graphical elements 114. Examples of graphical elements 114 include a dialog window, an application window, a block of text, or any other visual component in the user interface 110. The graphical elements 114 may display data to the user. In some embodiments, the graphical elements 114 are representative of computer files stored in either the memory 102 or the disk 108, and are displayed as icons indicative of a particular type of file. In other words, the graphical elements 114 may represent a text document, a spreadsheet, an email message, a calendar event, a video, etc.

The system 100 also includes an organizer 116. The organizer 116 dynamically aggregates and personalizes a user interface 110 that is presented to a user via the display device 112. The organizer 116 gradually aggregates the graphical elements 114 based on object property criteria that will be described in greater detail below. In one example, the organizer 116 aggregates icons displayed on a desktop and gradually migrates the icons from one position on the desktop to another position on the desktop based on similarities and dissimilarities of pairs or groupings of icons.

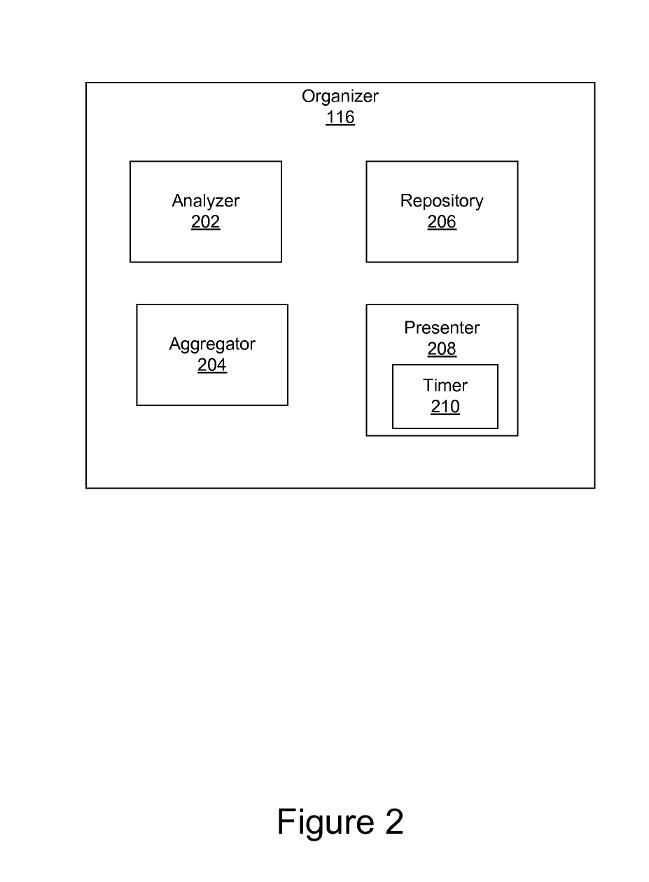

FIG. 2 is a schematic block diagram illustrating one embodiment of the organizer 116. In one embodiment, the organizer 116 includes an analyzer 202, an aggregator 204, a repository 206, and a presenter 208. The organizer 116 generates a dynamic directory structure based upon how graphical elements 114 are arranged and displayed on the display device 112. The term “directory structure” refers to the file system, or manner of organizing data on the disk 108 or other storage device.

The analyzer 202 evaluates all graphical elements 114 within the user interface to determine a degree of similarity between the graphical elements 114 by analyzing the properties of the graphical element 114 and the object associated with the graphical element 114. For example, a graphical element 114 may comprise an icon that is representative of a word processing document stored on the storage device or disk 108 of FIG. 1. As such, the analyzer 202 evaluates both the icon and/or the associated word processing document and the properties of both. Examples of properties include, but are not limited to, file name, file contents, file type, time since last modification, time since last accessed, file size, file creation date, file creator, etc.

The analyzer 202 compares the properties (also referred to as “classification attributes”) of a first graphical element 114 with a second graphical element 114 and generates the degree of similarity or measurements of similarity indices. The analyzer 202 repeats the comparison analysis for each possible pairing of graphical elements 114 displayed within the user interface as presented on the display device 112, and maintains an index of similarity values in the repository 206.

Examples of analysis techniques suitable for analyzing the similarity indices of all possible graphical element 114 pairings include, but are not limited to cluster analysis, swarm intelligence, and multidimensional scaling. These techniques, as known by those of skill in the art, explore the similarities and differences in data. The analyzer 202 may utilize these or other statistical modeling techniques to assign degrees of similarity to each possible pairing of graphical element.

The repository 206, in one embodiment, is a database configured to store the degree of similarity values or indices generated by the analyzer 202. In an alternative embodiment, the repository 206 may be a simple table, text document, or spreadsheet, for example, capable of storing the degree of similarity values. The degree of similarity may be a value within any predefined or automatically generated range of values for establishing a similarity relationship between graphical elements 114 and their respective associated objects. For example, the range of values may be numbers in the range of between 0 and 1, with the value 1 indicating that objects are identical and a value of 0 indicating no similarity between the objects.

The aggregator 204 incrementally moves similar graphical elements 114 into groupings based upon the degree of similarity generated by the analyzer 202. In one embodiment, the aggregator moves together graphical elements with a degree of similarity that exceeds a threshold value. Continuing the example from above, if the range of values is from 0-10, the threshold might be 6.0. Therefore, graphical elements with a degree of similarity of 6.1 or greater, for example, will be moved incrementally moved towards each other by the aggregator 204. The aggregator 204 identifies the positions of the graphical elements 114 with respect to one another on the display device 112. The position may be relative to the dimensions of the display device, or actual pixel coordinates, for example. Upon identifying the positions of the graphical elements 114, the aggregator 204 “moves” the graphical element 114 towards other similar graphical elements based on the degree of similarity.

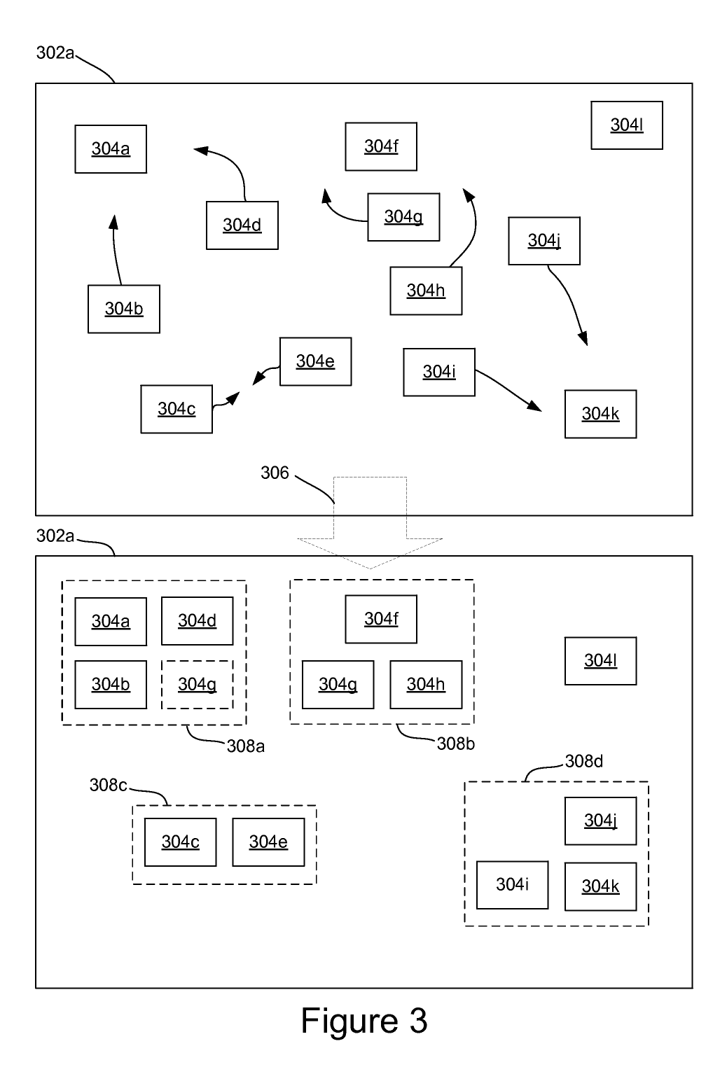

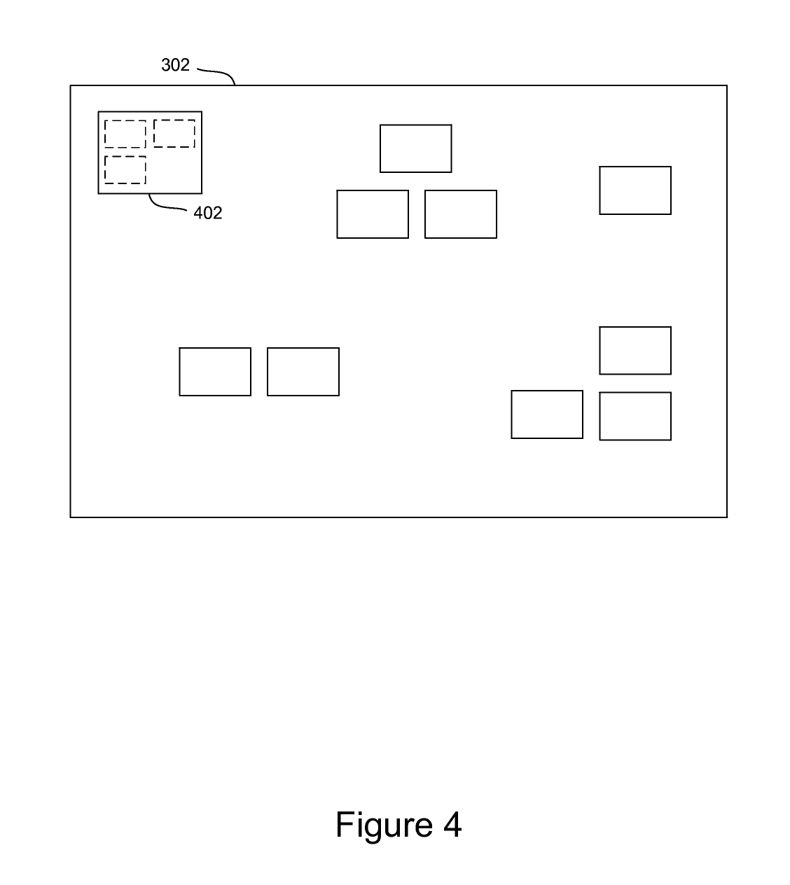

The movement of the graphical elements 114 is gradual to avoid the disruptive effects of a sudden, one-step, reorganization of graphical elements 114 or icons. The aggregator 204 moves pairs of graphical elements 114 with high similarity move towards each other to achieve a grouping, as will be described below with reference to FIGS. 3 and 4. The aggregator 204 may move the icons a small amount, for example, a few pixels, per time period. The time period may be a predetermined value, or a customizable value selected by a user. Stated differently, the aggregator 204 may move icons a few pixels each hour, day, week, etc., as determined by the preference of the user. Alternatively, the icons may be moved slightly each time the user views the user interface (for example, the desktop), or each time a user opens or closes a window, or each time the user logs into the system.

The presenter 208, in one embodiment, animates the movement of the icons to draw attention to the movement, thereby lessening the disruption of the automatic and gradual organizing of the user interface. Any number or type of animations may be used to highlight the movement of the icons, for example, a bouncing or sliding icon.

In a further embodiment, the presenter 208 modifies the “static” or non-moving appearance of the graphical elements 114 to represent the time since the graphical element 114 was last accessed. A timer 210 may maintain this time since the graphical element 114 was last accessed. The presenter 208 may decrease the opacity of the graphical element 114 as time passes since the graphical element 114 was last accessed. In other words, the presenter 208 modifies the appearance of the graphical element 114 by gradually fading the graphical element until the graphical element is no longer visible on a desktop or home screen. Alternatively, the presenter 208 may change a size of the graphical element 114. Eventually, the presenter 208 removes the graphical element 114 from the user interface and the organizer 116 moves the associated object into a different area of the file system. For example, the organizer 116 may move the object into a folder for objects that are accessed infrequently.

The presenter 208 also monitors how a user interacts with the graphical elements 114 and may modify the object attributes associated with the graphical elements 114 based upon the user interaction. For example, the presenter 208 may detect that the user has clicked on a specific graphical element 114 and consequently the presenter 208 may reset the timer 210 associated with that graphical element 114. Additionally, the presenter 208 may reset the opacity of the graphical element 114 to be fully opaque or reset a size to a default size.

In a further embodiment, the presenter 208 is configured to gradually group similar graphical elements 114 into a single representative icon. For example, if a certain amount of time passes and the user does not interact with one icon in a grouping of icons, the presenter 208 may gradually condense the group of icons into a single icon. The single icon may be depicted as a folder, in one example. This will be described below in greater detail with reference to FIG. 4.

After a group of icons has been condensed into a single icon, the analyzer 202 and aggregator 204 will repeat the above described process with the condensed icons. In other words, the analyzer 202 will evaluate the single condensed icon and generate new degrees of similarity to other graphical elements. Subsequently, the aggregator 204 begins to gradually move the single condensed icon towards other graphical elements 114 based upon the degree of similarity.

FIG. 3 is a schematic block diagram illustrating one embodiment of graphical element movement. The depicted embodiment illustrates a user interface as described above with reference to FIG. 1. Although FIG. 3 describes a desktop 302, it is to be understood that the features described herein also apply to any number of displays that involve representation of multiple discrete information objects that vary in relatedness and frequency of access. Further, the features may also be utilized in multi-user, collaborative environments to provide a consensus-based way of organizing a shared information space.

The desktop 302 displays multiple graphical elements or icons 304 (referred to collectively as “icons 304” and individually as “icon 304x”). The icons 304, as described above, are associated with objects stored on the disk 108. The icons 304 may have an appearance that indicates the type of associated object. For example, an icon 304a may depict a text document object, a spreadsheet object, a movie object, etc. Many users of graphical desktop systems save objects to the desktop 302 so that the objects remain readily accessible without searching or navigating through the file system. Over time, the desktop 302 becomes cluttered. FIG. 3 depicts an unorganized desktop 302a and one embodiment of an organized desktop 302b after the organizer 116 has processed and incrementally moved the icons 304. The steps of analyzing and aggregating, as performed by the organizer 116, are depicted in FIG. 3 by arrow 306, and described below in greater detail with reference to FIG. 5.

Icons 304 may be distributed in an arbitrary manner across the unorganized desktop 302a. The analyzer 202 evaluates each possible pairing of icons 304 to generate a degree of similarity. The analyzer 202 compares object properties including, but not limited to, object creation date, object type, object title, object size, time since last accessed, time since last modified, etc.

For example, the analyzer 202 may determine that icons 304a and 304b have a high degree of similarity, and the analyzer 202 may also determine that icons 304a and 304d also have a high degree of similarity. As icon 304a has multiple similar icons 304b, 304d, the aggregator 204 may decide to migrate the icons 304b, 304d towards icon 304a. The aggregator 204 gradually and incrementally moves the icons 304b, 304d towards icon 304a over a period of time. The period of time may be predefined or selectable by a user. For example, the time period may be one week. Stated differently, the time period for moving the icons 304b, 304d to a final position adjacent icon 304a may be one week. Accordingly, the aggregator 204 calculates the distance to move each icon each day in order to finish the migration within the time period.

In an alternative embodiment, the aggregator 204 may move pairs of similar icons 304 towards each other. For example, the aggregator moves icons 304c, 304e towards each other to form a grouping 308c of icons 304c, 304e. In certain embodiments, icons 304 may have an affinity or similarity towards two separate groupings 308a, 308b, or icons 304. For example, icon 304g may have a degree of similarity with icon 304a that is substantially equivalent to a degree of similarity with icon 304f. The organizer 116, in this situation, may generate a shortcut or pointer to the associated object (depicted as a dashed line icon 304g) in group 308a while the original icon 304g remains in group 308b.

FIG. 4 is a schematic block diagram illustrating one embodiment of a condensed graphical element 402. In one embodiment, the presenter 208 modifies the appearance of a group of icons. As time passes, the presenter 208 may condense the icons of a group into a single icon 402. The single icon 402, for example, may represent a folder that contains the group of icons. Eventually, if the user does not access any of the objects in the icon 402, the presenter 208 will remove the icon 402 and any objects it contains from the desktop 302. The time before the icon 402 is removed may be predetermined or selected by the user. For example, the time before the icon 402 is removed may be one month, or any other default time period or time period the user sets.

While a cluster of similar objects is not modified, the presenter 208 provides an indication that the organizer 116 will file them as a grouping 402. In one embodiment, the indication is a masking (illustrated here with dashed lines) that modifies the transparency of the objects inside the group 402. The timer 210 of FIG. 2 maintains the amount of time since the last time any of the objects in the grouping 402 were accessed. If the user drags one of the objects or icons away from the group 402, the analyzer 202 resets the previously generated degrees of similarity and updates the similarity indices of the moved object based on the relative distances between the objects at the end of the movement.

FIG. 5 is a schematic flow chart diagram illustrating one embodiment of a method 500 for organizing objects displayed on a user interface. The method 500 starts and the analyzer 202 of FIG. 2 analyzes 502 the objects on the user interface. In one embodiment, an example of objects displayed on a user interface includes files stored on a desktop of a computing device. The objects may represent various files such as text documents, spreadsheets, email files, calendar events, multimedia files, etc.

The analyzer 202 analyzes 502 the object properties or characteristics of each object displayed on the desktop. Examples of object properties that may be evaluated include, but are not limited to file name, file type, file creation date, file modification date, file accessed date, file size, file creator, etc. The analyzer 202 then compares the object properties of each object on the desktop with every other object on the desktop. In other words, the analyzer 202 generates 504 degrees of similarities between each possible pairing of objects on the desktop. These generated values may be stored in the repository 206 of FIG. 2.

The aggregator 204 then incrementally moves 506 the objects based on the generated degree of similarity. In one embodiment, moving 506 an object comprises determining which objects are most similar and subsequently moving the most similar objects towards each other. Objects may have multiple affinities, or in other words, similarity to different objects. The aggregator 204 may form groups of similar objects, or alternatively, generate a shortcut or link in one group that points to the original object in a second grouping.

As the aggregator 204 incrementally moves 506 the objects, the presenter 208 highlights the movement to draw attention towards the movement. As such, disruption of the user experience is minimized because the user is aware of the movement. Conversely, a system that abruptly reorganizes icons on a desktop creates maximum disruption to the user experience as the user searches his or her desktop for the new position of certain icons.

The organizer 116 monitors the desktop for modifications 508. Examples of modifications include, but are not limited to, new objects, deleted objects, and moved objects. Each of these changes causes the organizer 116 to initiate an analysis of objects by the analyzer 202. For example, if a user drags an object from a first grouping to a second grouping, the analyzer 202 resets the degree of similarity between the icon and the first grouping, and automatically establishes a high degree of similarity between the object and the second grouping.

While no modifications are being made, the presenter 208 monitors 510 the “age” of groupings and icons on the desktop. The presenter 208, in one embodiment, maintains a timer 210 for each object on the desktop to monitor the time since the user last accessed or modified the object. If a predetermined or user-selected age is reached 512, the presenter 208 marks the object and indicates that the object will be filed 514 away. In one embodiment, this marking or indication is a modification of the appearance of the object by modifying, for example, the transparency or size of the object. In a further embodiment, the presenter 208 may animate the transition of the object from the desktop to a folder not displayed on the desktop. The modification of the appearance of the object may be incremental in a manner similar to the movement of the objects. In other words, the objects incrementally fade until removed from the desktop. The method then ends.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

An embodiment of a system includes at least one organizer coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer usable storage medium for execution by a computer. As an example, an embodiment of a computer program product includes a computer usable storage medium to store a computer readable program that, when executed on a computer, causes the computer to perform operations, including an operation to monitor a pointer movement in a web page. The web page displays one or more content feeds. In one embodiment, operations to report the pointer movement in response to the pointer movement comprising an interaction gesture are included in the computer program product. In a further embodiment, operations are included in the computer program product for tabulating a quantity of one or more types of interaction with one or more content feeds displayed by the web page.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-usable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A computer program product comprising:
a computer readable storage medium to store a computer readable program, wherein the computer readable program, when executed by a processor within a computer, causes the computer to perform operations for designating a graphical element displayed in a user interface, the operations comprising:
evaluating object properties of a pair of graphical objects displayed on the display device;
comparing the object properties of each of the pair of graphical objects;
generating a degree of similarity for the pair of graphical objects; and
incrementally moving the pair of graphical objects based upon the degree of similarity.

2. The computer program product of claim 1, further comprising moving together graphical objects with a degree of similarity above a predetermined threshold.

3. The computer program product of claim 1, further comprising modifying the appearance of a graphical object based upon an age of the graphical object.

4. The computer program product of claim 3, further comprising maintaining the age of the graphical object, wherein the age is based upon one of: the time since a graphical object was last accessed; or the time since the graphical object was last modified.

5. The computer program product of claim 1, further comprising modifying at least one of a size and a transparency of the graphical object based upon a respective age of the graphical object.

6. The computer program product of claim 1, further comprising removing a graphical object from the display device in response to a determination that the age of the graphical object exceeds a threshold age.

7. A system comprising:
a display device;
an analyzer configured to:
evaluate object properties of a pair of graphical objects displayed on the display device;
compare the object properties of each of the pair of graphical objects; and
generate a degree of similarity for the pair of graphical objects; and
an aggregator configured to incrementally move the pair of graphical objects based upon the degree of similarity.

8. The system of claim 7, wherein the aggregator is further configured to move together graphical objects with a degree of similarity above a predetermined threshold.

9. The system of claim 7, wherein the object properties are selected from the group consisting of file name, file type, file size, file content, file creation date, file creator, time since last accessed, and time since last modified.

10. The system of claim 7, further comprising a presenter configured to modify the appearance of a graphical object based upon an age of the graphical object.

11. The system of claim 10, further comprising a timer configured to maintain the age of the graphical object, wherein the age is based upon one of: the time since a graphical object was last accessed; or the time since the graphical object was last modified.

12. The system of claim 11, wherein the presenter is further configured to modify at least one of a size and a transparency of the graphical object based upon a respective age of the graphical object.

13. The system of claim 10, further comprising an organizer configured to remove a graphical object from the display device in response to a determination that the age of the graphical object exceeds a threshold age.

14. The system of claim 7, further comprising a repository configured to maintain the degree of similarity value for each possible pairing of graphical elements.

15. A method comprising:
evaluating object properties of a pair of graphical objects displayed on the display device;
comparing the object properties of each of the pair of graphical objects;
generating a degree of similarity for the pair of graphical objects; and
incrementally moving the pair of graphical objects based upon the degree of similarity.

16. The method of claim 15, further comprising moving together graphical objects with a degree of similarity above a predetermined threshold.

17. The method of claim 15, further comprising modifying the appearance of a graphical object based upon an age of the graphical object.

18. The method of claim 17, further comprising maintaining the age of the graphical object, wherein the age is based upon one of: the time since a graphical object was last accessed; or the time since the graphical object was last modified.

19. The method of claim 15, further comprising modifying at least one of a size and a transparency of the graphical object based upon a respective age of the graphical object.

20. The method of claim 15, further comprising removing a graphical object from the display device in response to a determination that the age of the graphical object exceeds a threshold age.
